(19) United States
(12) Patent Application Publication
(10) Pub. No.: US 2025/0369271 A1
(43) Pub. Date: Dec. 4, 2025

(54) DEVICE FOR RECEIVING AND RELEASING A CABLE-TYPE TENSION ELEMENT

(71) Applicant: Stabilus GmbH, Koblenz (DE)

(72) Inventor: Thomas Reif, Kobern-Gondorf (DE)

(21) Appl. No.: 19/212,939

(22) Filed: May 20, 2025

(30) Foreign Application Priority Data
May 31, 2024 (DE) 102024115224.9

(51) Int. Cl. E05F 15/627; B62D 33/03

(52) U.S. Cl. CPC E05F 15/627; B62D 33/03; E05Y 2201/672; E05Y 2900/544

(57) ABSTRACT

The present invention relates to a device (10) for receiving and releasing a cable-type tension element (12), comprising the tension element (12), a receiving unit (18) for receiving the tension element (12), a drive unit (20) for driving the receiving unit (18), a stop element (24) which is connected to the tension element (12) at a predefined point such that the stop element is immovable at least axially to a longitudinal extension of the tension element (12), and a counter-stop element (34) through which at least portions of the tension element (12) are led and which is designed to come into contact with the stop element (24), wherein the stop element (24) is connected to the receiving unit (18) such that, after a predefined length of tension element (12) has been released from the receiving unit (18) and has been led through the counter-stop element (34), the stop element (24) comes into contact with the counter-stop element (34) in a force-transmitting manner. The invention also relates to a corresponding vehicle flap arrangement (42).

The present invention relates to a device for receiving and releasing a cable-type tension element.

Devices for receiving and releasing a cable-type tension element which are firmly connected to one end of the tension element are known from the prior art. If the tension element is fully unwound from the receiving unit and tensile forces are introduced into the tension element, these tensile forces will be transferred directly to the receiving unit. This in turn means that both the receiving unit itself and a connection of the receiving unit to a higher-level assembly, such as a vehicle flap, must be designed to be sturdy enough to withstand all occurring forces without damage. This inevitably leads to an increase in the size and/or weight of the device. It is precisely in automotive engineering, where weight and size play a central role due to the very limited installation space available for such devices, that a device optimized in this regard can bring decisive advantages.

It is therefore the object of the present invention to provide a device which can provide force transmission comparable to the prior art and at the same time can be designed in an optimized manner, in particular with regard to size and/or weight.

This object is achieved according to the present invention by a device for receiving and releasing a cable-type tension element, the device comprising:
the cable-type tension element designed to transmit tensile forces,
a receiving unit designed to receive the tension element so that a free length of the tension element extending away from the receiving unit is shortened, or to release the tension element so that a free length of the tension element extending away from the receiving unit is lengthened,
a drive unit, in particular an electric motor, designed to drive the receiving unit,
a stop element which is connected to the tension element at a predefined point such that the stop element is immovable at least axially in relation to a longitudinal extension of the tension element, and
a counter-stop element through which at least portions of the tension element are led and which is designed to come into contact with the stop element,
wherein the stop element is connected to the receiving unit such that, after a predefined length of tension element has been released from the receiving unit and has been led through the counter-stop element, the stop element comes into contact with the counter-stop element in a force-transmitting manner.

If, in the state in which the stop element and the counter-stop element are in contact with one another, a tensile force is introduced into the tension element, for example due to application of load to the fully open vehicle flap, the tensile force is introduced from the tension element via the stop element directly into the counter-stop element. The counter-stop element is in turn connected, in a force-transmitting manner, to a higher-level assembly, for example a vehicle flap or a vehicle body, so that the forces can be introduced from the counter-stop element into this higher-level assembly.

As can be seen from the force progression described above, the present invention makes it possible for the receiving unit and/or a housing which surrounds the receiving unit and/or a fastening of the receiving unit to the higher-level assembly not to form part of the force progression, so that the receiving unit/the housing/the fastening essentially does not have to be designed to withstand and transmit forces which are introduced via the tension element. As a result, the receiving unit and/or the housing and/or the fastening of the receiving unit to the higher-level assembly can be designed with significantly less material in comparison with similar but force-transmitting components, thereby reducing weight and size.

In particular, the stop element can be connected to one end of the tension element. The stop element can be screwed, riveted, cast-on, glued, welded or otherwise connected to the tension element in a force-transmitting manner. Of course, it is also conceivable for the tension element to project from the stop element on two sides, in which case forces are transmitted via the tension element only on one side. For this reason, the portion of the tension element at which forces are transferred from the tension element can be considered the “end” of the tension element, regardless of whether the tension element physically ends at this point or not. In principle, the entire system is also conceivable as a two-sided application with two devices/cable drives.

In an advantageous embodiment of the present invention, the receiving unit can comprise a cable reel designed to wind the tension element onto the cable reel by rotation of the cable reel about an axis of rotation in a first direction of rotation and to unwind the tension element from the cable reel by rotation of the cable reel about the axis of rotation in a second direction of rotation and thus to release the tension element from the receiving unit. Winding the tension element onto and releasing the tension element from a cable reel is a particularly advantageous method of repeatably receiving and releasing the tension element without the tension element becoming knotted and thus interfering with the function of the device. The cable reel can have recesses, such as grooves on the outside of the cable reel, which are designed and dimensioned to receive the tension element therein, in particular such that only a single portion of the tension element is arranged in a single recess. For example, a continuous recess can be arranged which runs on the cable reel in the manner of a screw thread.

The stop element can be connected to the receiving unit in an articulated manner, in particular so as to be pivotable about a pivot axis. In this way, in the region of the stop element the tension element can approach a receptacle for the tension element on the receiving unit without kinking and can also orient itself away from the receiving unit in accordance with the course of the tension element. This can prevent damage to the tension element, for example due to kinking of the tension element in the region of the stop element.

In a state in which the tension element is received in the receiving unit, the tension element can be in contact with the stop element, in particular with a radially outer side of the stop element. That is to say, the stop element can be overlaid, on its radially outer side, with a portion of the tension element when the tension element has been received sufficiently far on the receiving unit. The tension element can thus first extend away from the stop element towards an outer circumference of the receiving unit and then run along the outer circumference of the receiving unit, the tension element running radially outside at least partially over the stop element after approximately one complete wrap around the receiving unit.

Furthermore, the stop element can be arranged such that it can be at least partially recessed with respect to a region of the receiving unit, in particular with respect to an outer circumference of the cable reel, on which outer circumference the tension element is received. The stop element can be arranged such that it can be recessed in the receiving unit to such an extent that a radially outer side of the stop element is essentially flush with a portion of the receiving unit that surrounds the stop element. If, in a receiving region of the receiving unit, several turns of tension element are arranged next to one another (in the sense of a first layer of tension element having an essentially constant first distance from an axis of rotation of the cable reel), the stop element can also be overlaid, in particular on its radially outer side, with a portion of the tension element, without the portion of the tension element with which the stop element is overlaid projecting farther radially outwards than the rest of the same layer of tension element. Furthermore, it is conceivable that a second such layer of tension element can be arranged radially outside the first layer and optionally in contact with the first layer, the second layer similarly having an essentially constant second distance from the axis of rotation of the cable reel.

Advantageously, the counter-stop element can have a tension element guide which runs through the counter-stop element, the contour of the tension element guide being essentially L-shaped. The tension element guide can be at least partially, in particular fully, closed with respect to its peripheral direction.

One leg of the L-shape of the tension element guide can extend in a direction parallel to an axis of rotation of the receiving unit and the other leg can extend essentially orthogonally thereto and orthogonally to a longitudinal extension of the tension element in the region of the tension element guide. The leg extending parallel to the axis of rotation of the receiving unit can thus be designed to correspond to or allow a lateral displacement of the tension element during release from the receiving unit, for example during unwinding from the cable reel. The leg of the L-shape running orthogonally thereto can be designed to allow a displacement of the tension element orientation from a course which runs essentially tangentially relative to the cable reel to a course which the tension element assumes when it is fully released (unwound from the cable reel) and the stop element is in contact with the counter-stop element.

The counter-stop element can have a counter-stop surface which is oriented and dimensioned such that, when the stop element is in contact with the counter-stop element, surface-to-surface contact between the counter-stop surface and a stop surface formed on the stop element is established.

For example, the surface-to-surface contact amounts to at least 80%, in particular at least 90%, advantageously approximately 100% of the stop surface of the stop element. Basically, the surface-to-surface contact depends on the required support force and thus on the contact pressure. Of course, regard should be given here to a macroscopic contact visible to the naked eye. Furthermore, unevenness or non-parallelism, which may arise, for example, due to manufacturing tolerances and the particular material properties, should be disregarded. By such surface-to-surface contact a particularly favorable force transmission from the stop element to the counter-stop element can be achieved.

For this purpose, the stop surface of the stop element can be formed on an end face of the stop element, in particular the end face at which the tension element is connected to the stop element. This means that a tensile force introduced into the tension element can directly lead to a contact force between the stop element and the counter-stop element. Since the tension element can thus assume an essentially straight course, it can be protected from damage.

In particular, the device can also comprise a spring element, in particular a coil spring, which is designed to preload the receiving unit in such a way that a tension of the tension element is maintained or is restored after a decrease in the tension of the tension element. If, for example, the vehicle flap is manually closed faster than the motor drive can perform this, the tension element may become tension-free and possibly sag. In order to prevent the tension element from becoming trapped between the vehicle flap and another region of the vehicle, the tension element is received in the receiving unit due to the effect of the spring element, preferably in combination with a freewheel in the cable reel for this direction of rotation.

In this context, but not limited thereto, it may be advantageous that the receiving unit can comprise a freewheel designed to enable a relative movement, in particular rotation, of a first subassembly of the receiving unit, which is operatively connected to the drive unit, relative to a second subassembly of the receiving unit, which is connected to the tension element, in at least one direction, in particular in at least one direction of rotation, advantageously in the direction of rotation in which the tension element is received into the receiving unit. For example, the spring element can thus cause the tension element to be received on the receiving unit, in particular wind it onto the cable reel, even though the drive unit is stationary or at least moving at a lower speed.

According to a further aspect, the present invention relates to a vehicle flap arrangement which comprises a vehicle flap, in particular a dropgate, and a device according to the invention for receiving and releasing a cable-type tension element,
wherein the vehicle flap is connected so as to be movable, in particular pivotable, relative to a vehicle body,
wherein the tension element connects the device to the vehicle body in the case in which the device is arranged on the vehicle flap and to the vehicle flap in the case in which the device is arranged on the vehicle body.

The term “dropgate” generally refers to the vehicle flap attached to the rear of the vehicle body.

It should already be pointed out here that all features, effects and advantages described with reference to the device according to the invention can also be applied to the vehicle flap arrangement according to the invention, and vice versa.

For example, in the vehicle flap arrangement according to the present invention, a longitudinal extension of the tension element guide, in particular a longitudinal extension of that leg of the L-shape which extends in a direction parallel to an axis of rotation of the receiving unit, can be arranged essentially orthogonally to a main surface, in particular an inner side, of the vehicle flap. The axis of rotation of the receiving unit, in particular of the cable reel, can also be arranged essentially orthogonally to a main surface, in particular an inner side, of the vehicle flap. This can lead to a particularly space-saving arrangement of the device for receiving and releasing a cable-type tension element in the vehicle flap or in the vehicle body.

Furthermore, the vehicle flap arrangement can also comprise a guide pulley, the axis of rotation of which has an angle between 0° and 22.5°, in particular of approximately 22.5°, relative to a plane which is normal to the axis of rotation of the receiving unit. This can make it possible for the tension element, as seen from the receiving unit, to run centrally into a groove of the guide pulley, then extend around the guide pulley by a predefined angle, for example by approximately 90°, and then leave the guide pulley in such a way that the tension element leads away from the guide pulley via a first side flank of the guide pulley in the case of a closed position of the vehicle flap on the body, that the tension element leads away from the guide pulley via a second side flank of the guide pulley in the case of a fully open position of the vehicle flap on the body, and that the tension element leads away from the guide pulley via the groove of the guide pulley in the case of a middle position of the vehicle flap on the body, the middle position being located centrally between the fully open position and the closed position. In particular, the axis of rotation of the guide pulley can be arranged relative to the axis of rotation of the receiving unit such that they do not intersect.

The present invention is described in greater detail below on the basis of an exemplary embodiment, with reference to the accompanying drawings. In the drawings:

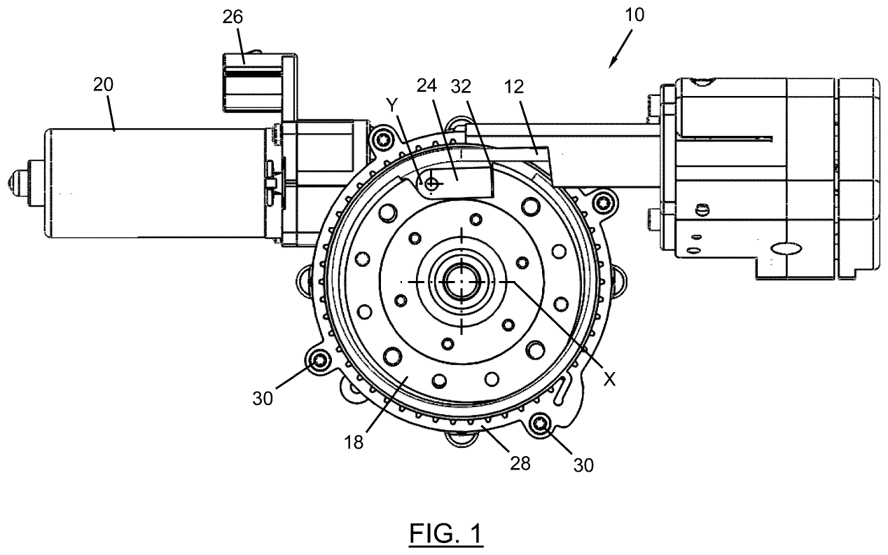

FIG. 1 shows an embodiment of the device according to the invention with the tension element received;

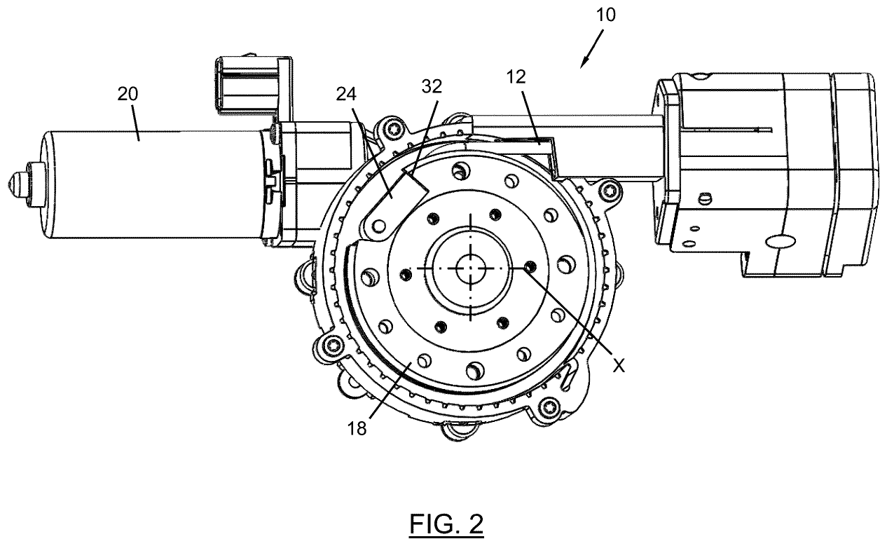

FIG. 2 is a side view of the device from FIG. 1 with the tension element partially released;

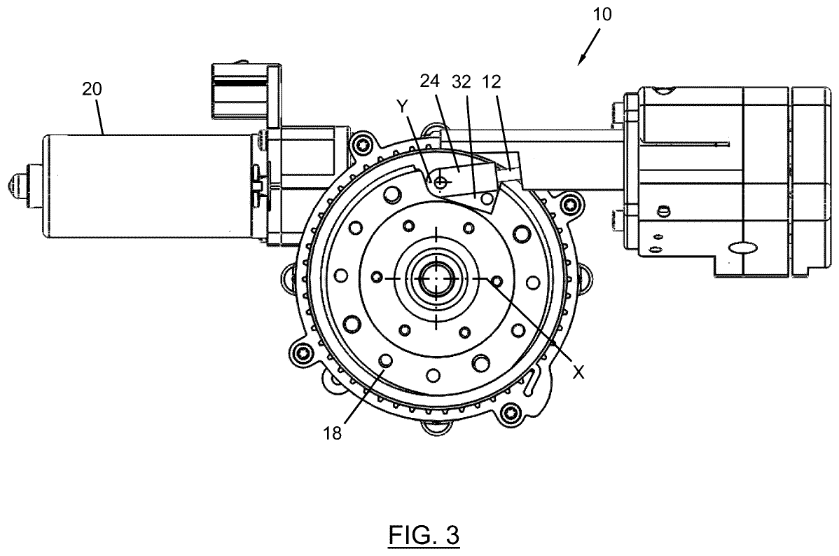

FIG. 3 is a side view of the device from FIG. 1 with the tension element almost fully released;

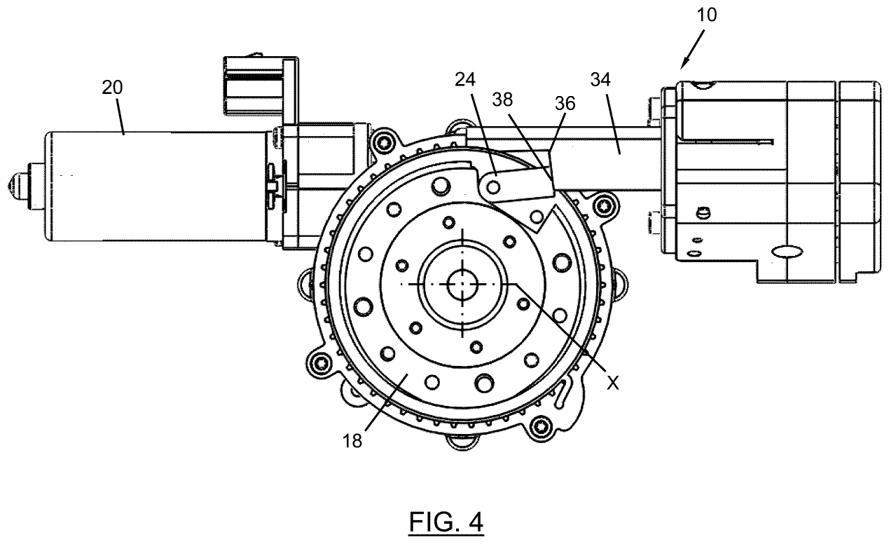

FIG. 4 is a side view of the device from FIG. 1 with the tension element fully released;

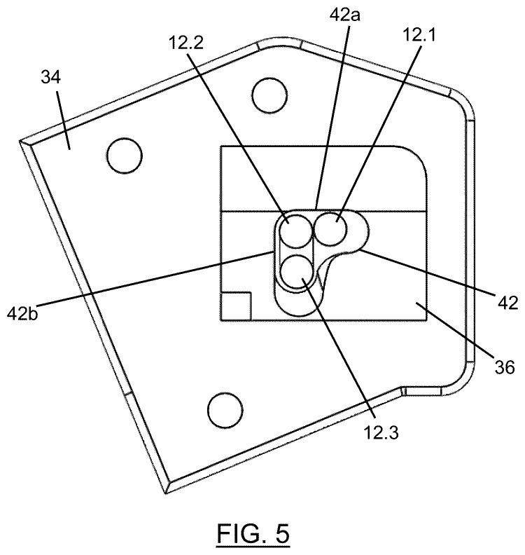

FIG. 5 is a detail view of the device from FIG. 1;

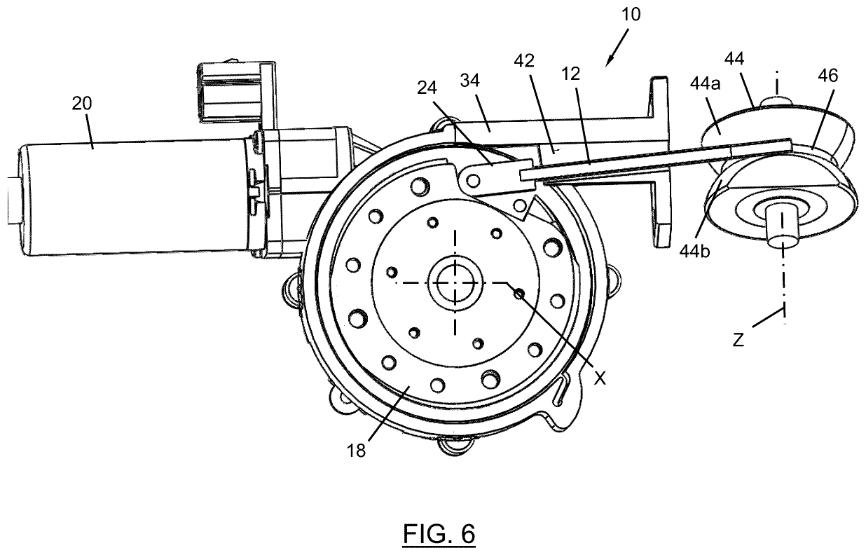

FIG. 6 is a side view of the device from FIG. 1 in a partially sectioned state; and

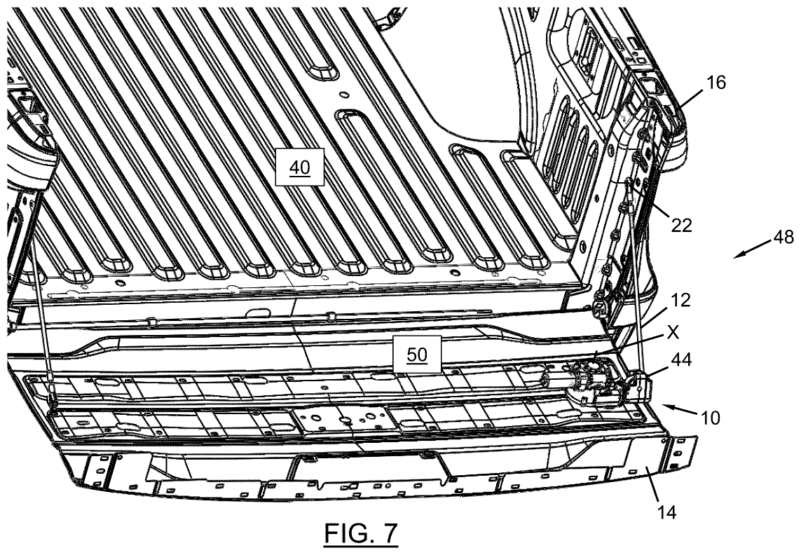

FIG. 7 is a perspective view of a vehicle flap arrangement according to the invention; and

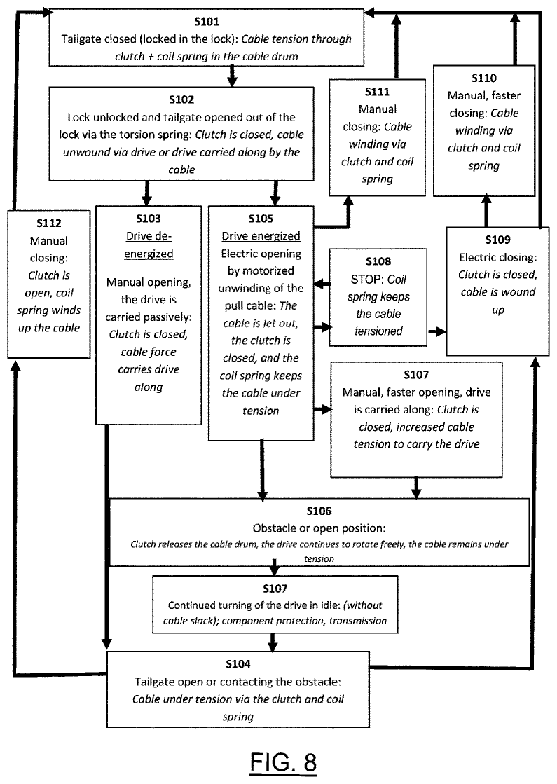

FIG. 8 is a flowchart of possible action sequences during opening/closing of the vehicle flap arrangement.

In FIG. 1, a device according to the invention for receiving and releasing a cable-type tension element is denoted overall by the reference sign 10. The device 10 comprises the cable-type tension element 12, wherein the tension element 12 runs between a vehicle flap 14 and a vehicle body 16 (see FIG. 7), and wherein the tension element 12 is designed to transmit tensile forces so that the vehicle flap 14 can be moved or pivoted relative to the vehicle body 16 and can be held in a predefined open position relative to the vehicle body 16.

In the situation shown in FIG. 1, the tension element 12 is fully received on a receiving unit 18, which, in the exemplary embodiment shown here, takes the form of a cable reel 18, such that the tension element 12 wraps around the cable reel 18 several times in turns which, in the sense of a first layer of the tension element 12 on the cable reel 18, are arranged next to one another in relation to a direction running parallel to an axis of rotation X of the cable reel 18. In general, it is also conceivable for this first layer of tension element 12 to be in turn covered radially outward, in relation to a direction radial to the axis of rotation X, by portions of the tension element 12 (in the sense of a second layer of tension element 12).

In order to drive the cable reel 18 in rotation about the axis of rotation X, the device 10 also comprises a drive unit 20, which here takes the form of an electric motor 20 and is operatively connected to the cable reel 18 by means of a corresponding transmission unit (not shown).

As already mentioned above, one longitudinal end 22 of the tension element 12 is connected to the body 16. At its other longitudinal end, the tension element 12 is connected to a stop element 24, which is attached to the cable reel 18 so as to be pivotable about a pivot axis Y.

The situation, shown in FIG. 1, of the fully received tension element 12 corresponds to a fully closed vehicle flap 14 on the vehicle body 16.

In FIG. 1 it can also be seen that the drive unit 20 is assigned a connector 26 which serves as a connection point for an electrical cable via which power and, if necessary, control signals can be supplied to the drive unit 20. It can also be seen that the receiving unit 18 (here, the cable reel 18) is accommodated in a housing 28, which is connected to the vehicle flap 14 by connecting elements 30 (see FIG. 7). It should be mentioned that it is of course also conceivable for the device 10 to be connected to the vehicle body 16 and the free end 22 of the tension element 12 to be attached to the vehicle flap 14

In the situation according to FIG. 1, the stop element 24 is fully recessed in a receptacle 32, so that the stop element can be overlaid, radially outwardly, with a portion of the tension element 12, without the tension element 12 being deflected radially outwardly at this point. The shape of the recess 32 essentially corresponds to the contour of the stop element 24.

With reference now to FIG. 2, it can be seen that the tension element 12 has been unwound to its furthest extent from the cable reel 18. Nevertheless, the tension element 12 still leaves the cable reel 18 essentially tangentially to an outer circumference of the cable reel 18, similarly to the situation according to FIG. 1. Also similarly to the situation according to FIG. 1, in the situation according to FIG. 2 the stop element 24 is likewise recessed as far as possible in the receptacle 32.

If the cable reel 18 is now further driven by the drive unit 20 about the axis of rotation X such that the tension element 12 is released even further, i.e. that the vehicle flap 14 is opened even further, the stop element 24 will begin to lift out of the receptacle 32 by a pivoting movement about the pivot axis Y. In this state according to FIG. 3, the tension element 12 no longer runs tangentially to the cable reel 18, but rather in a straight line towards the pivot axis Y, which is arranged further radially inwardly than an outer circumference of the cable reel 18. This lifting of the stop element 24 out of the receptacle 32 takes place automatically due to a corresponding amount of tension element 12 having been unwound from the cable reel 18.

In the situation according to FIG. 4, in which the tension element 12 has been fully released, i.e. the vehicle flap 14 is fully open relative to the vehicle body 16, the stop element 24 strikes a counter-stop element 34, the counter-stop element 34 having a counter-stop surface 36 which is oriented such that surface-to-surface contact is established between the counter-stop element 34 or the counter-stop surface 36 and the stop element 24 or a stop surface 38 formed on the stop element 24. Due to this surface-to-surface contact, even higher tensile forces can be transmitted between the two elements 24 and 34 without damage occurring.

In this fully open position of the vehicle flap 14, which corresponds to the situation according to FIG. 4 of the device 10, a load on the vehicle flap 14 results in a force progression which is introduced from the vehicle flap 14 into the counter-stop element 34, which is connected to the vehicle flap 14 in a force-transmitting manner, for example by connection to a side wall (not shown in FIG. 7) of the vehicle flap 14, and into the tension element 12 via the surface-to-surface contact of the counter-stop surface 36 with the stop surface 38 of the stop element 34. Via the tension element 12 or its longitudinal end 22 which is connected to the vehicle body 16, the tensile force is then transferred to the vehicle body 16. As can be seen, there is no force progression from the stop element 24 into the cable reel 18 via the pivot connection to the cable reel 18, so that the cable reel 18 itself and components connected thereto, such as a bearing system of the cable reel 18, can be designed so as to save material, since they only have to withstand the loads during the opening and closing processes of the tailgate 14 but not the loads that usually occur when the vehicle flap 14 is fully open, such as loading the cargo bed 40 of the vehicle partially shown in FIG. 7 or people standing on the vehicle flap 14.

In FIG. 5, the counter-stop element 34 is shown in a detail view which corresponds to a viewing direction from left to right in FIGS. 1 to 4.

It can be seen that the counter-stop element 34 has a tension element guide 42 through which the tension element 12 passes through the counter-stop element 34. Three arrangement states 12.1, 12.2 and 12.3 of the tension element 12 are shown superposed in FIG. 5 and are described below. The state 12.1 of the tension element 12 corresponds to the situation according to FIG. 1, in which the tension element 12 has been fully wound onto the cable reel 18 and in which the tension element 12 leaves the cable reel 18 essentially tangentially. If the tension element 12 is now unwound from the cable reel 18, due to the screw-thread-like turns of the tension element 12 around the cable reel 18 the point at which the tension element 12 leaves the cable reel 18 essentially tangentially shifts along a direction which runs essentially parallel to the axis of rotation X of the cable reel 18. This state, in which the mutually adjacent turns of the tension element 12 on the cable reel 18 are unwound, but in which the tension element 12 still leaves the outer circumference of the cable reel 18 essentially tangentially, is shown in FIG. 2 and corresponds to the state 12.2 of the tension element 12 in FIG. 5. If the tension element 12 is now further unwound from the cable reel 18 from this position unto the fully released position, the stop element 24 begins to lift out of the recess 32 and at the same time the course of the tension element 12 relative to the cable reel 18 changes from the essentially tangential course towards a course that intersects the outer circumference of the cable reel 18, as shown in FIGS. 3 and 4. In this phase of the releasing of the tension element 12 from the cable reel 18, the course of the tension element 12 thus does not change parallel to the axis of rotation X (corresponding to the change in state of the tension element 12 from 12.1 to 12.2 according to FIG. 5) but rather changes in a direction that is essentially orthogonal thereto (corresponding to the change in state of the tension element 12 from 12.2 to 12.3 in FIG. 5). The state 12.3 then corresponds to the fully released position of the tension element 12, in which the stop element 24 and the counter-stop element 34 are in contact with one another.

The tension element guide 42 can be described as being essentially L-shaped, wherein a first leg 42a of the L-shape has an extension which runs essentially parallel to the axis of rotation X of the receiving unit 18, and wherein a second leg 42b of the L-shape has an extension which runs skewed but, viewed in the projection direction along a shortest distance between the two axes, essentially orthogonally to the axis of rotation X of the cable reel 18. In this way, the tension element guide 42 can permit the displacements of the tension element 12 relative to the receiving unit 18 which are described above, without the tension element 12 having to be significantly deflected on the tension element guide 42, which could result in increased wear on or even damage to the tension element 12.

FIG. 6 shows that the tension element 12 can run onto a guide pulley 44 (see also FIG. 7) after leaving the counter-stop element 34. The guide pulley 44 serves to redirect the course of the tension element 12 in such a way that the tension element runs towards the vehicle body 16 in order to be able to be connected thereto.

It can be seen that an axis of rotation Z of the guide pulley 44 is arranged at an angle to a plane to which the axis of rotation X of the receiving unit 18 is normal (this plane corresponds to the plane of the drawing in FIG. 6). This angle can be, in particular, 22.5°. In this way, the tension element 12 coming from the receiving unit 18 can run into a groove 46 of the guide pulley 44, then extend around the guide pulley 44 by a predefined angle (see FIG. 7) and thereafter leave the guide pulley via a first side flank 44a or via a second side flank 44b. For example, when the vehicle flap 14 is in the fully open position, the tension element 12 can leave the guide pulley 44 via its first side flank 44a, and in the case of a fully closed state of the vehicle flap 14 on the vehicle body 16, the tension element 12 can leave the guide pulley 44 via its second side flank 44b. In a middle position of the vehicle flap 14, which is located essentially centrally between the fully open position and the closed position of the vehicle flap 12 relative to the vehicle body 16, the tension element 12 can run not only coming from the receiving unit 18 into the groove 46 of the guide pulley 44 but also leave the guide pulley 44 again via the groove 46 after corresponding wrapping. An angle at which the tension element 12 leaves the guide pulley 44 via the corresponding side flank 44a or 44b relative to the axis of rotation Z of the guide pulley can be essentially the same, but with different signs, in the fully open position of the vehicle flap 14 relative to the vehicle body 16 and in the closed position of the vehicle flap 14 on the vehicle body 16.

FIG. 7 shows a vehicle flap arrangement 48 according to the invention. In the embodiment shown here, the device 10 is arranged on the vehicle flap 14. In FIG. 7, the vehicle flap 14 is in the fully open position relative to the vehicle body 16, and thus the stop element 24 and the counter-stop element 34 are in contact with one another. Here, the axis of rotation X of the receiving unit 18 is essentially orthogonal to a main surface 50 of the vehicle flap 14, the main surface 50 here being an inner side of the vehicle flap 14, i.e. a side which essentially faces upwards when the vehicle flap 14 is in the fully open position. The tension element 12 extends from the receiving unit 18 to the guide pulley 44 essentially in a width direction of the vehicle flap 14.

FIG. 8 shows a flowchart illustrating possible action sequences during opening/closing of the flap arrangement 48.

Starting from a closed dropgate, i.e. the vehicle flap/the dropgate of the flap arrangement 48 being locked in a lock on the vehicle body 16 (step S101 in FIG. 8), in this closed position the cable tension is generated by the freewheel and a spring element (for example a coil spring) in the cable drum or cable reel 18. If the lock is unlocked and the dropgate is moved out of the closed position by the action of, for example, a torsion spring, the freewheel is rotated in its locking direction, i.e. the freewheel is closed, and the cable or tension element 12 is unwound from the cable reel 18 via the drive (drive unit 20) or, if the drive does not rotate the cable reel 18 sufficiently quickly in relation to the movement of the dropgate to unwind the tension element 12, the drive is carried along by the tension element 12 as a result of the movement of the dropgate (step S102).

In a first case of step S103, the drive is actuated while de-energized, i.e. the vehicle flap is opened manually and the drive is passively carried along. The freewheel remains closed and the drive is actuated by the cable force. If the dropgate has reached the end of its movement in the open position or has been stopped in an intermediate position, for example due to contact with an obstacle, the tension element 12 remains tensioned by means of the freewheel and the coil spring (step S104).

In a second case (step S105), the drive for driving the cable reel 18 is actively actuated. In this case, the vehicle flap is opened by the unwinding of the tension element 12 from the cable reel 18 due to the effect of the drive. That is to say, the tension element 12 is let out, the freewheel is closed and the coil spring keeps the tension element 12 under tension. If the dropgate now reaches the open position or, as described above, rests against an obstacle (step S106), the freewheel releases the cable reel 18 so that the drive continues to rotate freely and the tension element 12 thus remains under tension. In a subsequent step S107, the drive can continue to turn in idle, whereby components of the transmission of the drive can be protected without a significant reduction in the cable tension.

The action sequence then proceeds to the aforementioned step S104, in which the tension element 12 is under tension via the freewheel and the coil spring.

As an alternative to step S106, during active operation of the drive to open the dropgate (step S105) the dropgate can additionally be manually moved towards the open position such that a speed of the manual opening exceeds the speed of the motor drive speed of the drive. In this case, the freewheel is closed and the drive is carried along as a result of the manual movement of the dropgate. This can lead to increased cable tension. This is followed by step S106 described above.

Furthermore, active actuation of the drive and thus driving of the cable reel 18 can also be actively stopped (step S108) before the vehicle flap has reached the open position or has come into contact with an obstacle. As during the unwinding of the tension element 12, the tension element 12 is kept under tension by the coil spring. The active driving of the drive (step S105) can then be continued or the dropgate can be opened further manually (step S103) (not shown in FIG. 8). Alternatively, the drive can be driven in a step S109 such that the dropgate is moved towards its closed position by the action of the drive, i.e. motorized winding of the tension element 12 onto the cable reel 18. The freewheel is closed and the tension element 12 is wound onto the cable reel 18. At the end of the movement path, the dropgate returns to its closed position according to step S101 described above.

Likewise during closing of the dropgate under the action of the drive, analogously to the motorized opening of the dropgate, the vehicle flap can be manually acted upon in such a way that a movement speed of the vehicle flap towards the closed position exceeds the speed with which the drive winds the tension element 12 onto the cable reel 18. In this case, a decreasing cable tension is compensated by the freewheel and the coil spring, so that the tension element 12 can be wound onto the cable reel 18 at a higher speed than the action of the drive alone would allow (step S110). The action sequence then returns to step S101 when the dropgate has reached its closed position.

Of course, this manual closing can also take place without prior activation of the drive in order to close the dropgate, for example directly while the drive is still being actuated in the opening direction of the dropgate.

Analogously to step S110, in this case too the tension element 12 is wound onto the cable reel 18 via the freewheel and the coil spring so that sagging of the tension element 12 can be prevented.

In many cases, the dropgate will be moved into its open position (step S104) in order, for example, to load objects onto a cargo bed of a pick-up truck, and after step S104 the dropgate is then either electrically closed (step S109) or manually closed (step S112), wherein in step S112 the freewheel is opened and the coil spring winds the tension element 12 onto the cable reel 18. The dropgate then returns to its closed position (S101).

Of course, step S112 can also directly follow step S108 (not shown in FIG. 8).

The spring element (for example a coil spring) can preferably always have a spring preload, the lowest spring preload when the tension element 12 is wound up and the vehicle flap is closed, the highest spring preload when the tension element 12 is unwound and the vehicle flap is open. In order to be able to compensate for this resulting closing torque of the coil spring on the vehicle flap, a torsion spring with an opening torque on the vehicle flap is initially required and, with a larger opening angle of the vehicle flap, the resulting opening torque from the center of gravity of the flap (minus the torsion spring torque then acting in the closing direction) is then required to continue unwinding the coil spring.

The freewheel can in particular be arranged inside the cable reel 18 and can connect an electric-motor-driven cable drum shaft or cable reel shaft to the cable reel 18. If the cable reel shaft is driven by electric motor in the winding direction of the tension element 12, this is the locking direction of the freewheel and the outer cable reel 18 is carried along, likewise rotates in the winding direction of the tension element 12 and winds up the tension element 12, i.e. the vehicle flap closes.

If the vehicle flap is open and the cable reel shaft is not driven by electric motor in the winding direction of the tension element 12, but rather the vehicle flap is closed manually, the cable tension is reduced, the freewheel is open in this direction of rotation and the cable reel 18 can be driven by the coil spring preload, turn freely in the winding direction of the tension element 12 and keep the tension element 12 under tension or wind it up.

Even if the tension element 12 is detached from the vehicle door, for example to remove the dropgate, the tension element 12 will try to run completely onto the cable reel 18 due to the coil spring preload. The tension element 12 wants to disappear into the drive, so to speak, and must be manually pulled back out of the drive against the coil spring force in order to be reattached to the vehicle flap.

In principle, the freewheel in this arrangement can, at the same time, have four states, which always depend on the direction of rotation of the outer cable reel 18 relative to the inner driven cable reel shaft and on the speed and magnitude of the cable tension of the outer cable reel 18 relative to the inner cable shaft.

These states are:
1. cable reel shaft driven in the winding direction of the tension element 12, cable reel shaft turns faster than cable reel 18, freewheel is closed, cable reel 18 is carried along at the speed of the cable reel shaft, tension element 12 winds up, vehicle flap closes;
2. cable reel shaft is driven in the winding direction of the tension element 12, cable reel axis turns more slowly (or stops) than cable reel 18 (for example, fast manual closing of the flap results in a high cable reel speed), freewheel opens, cable reel 18 turn faster than cable reel shaft (due to the coil spring), tension element 12 is wound up quickly, cable tension is always maintained;
3. cable reel shaft driven in the unwinding direction of the tension element 12, cable tension sufficiently high due to opening torque on the vehicle flap, freewheel closed, the cable reel 18 is allowed to unwind the tension element 12 at the speed of the cable reel shaft in the unwinding direction of the tension element 12; no matter how high the opening torque of the vehicle flap=cable force is, the cable reel 18 cannot unwind faster than the speed of the cable reel shaft, freewheel is closed, “motor-braked opening speed”;
4. cable reel shaft driven in the unwinding direction of the tension element 12, cable tension due to opening torque on the vehicle flap too low (e.g. the vehicle flap is prevented from opening), if there is no opening torque and the cable tension is thus greatly reduced, the coil spring which wants to wind up predominates, freewheel opens, the cable reel 18 will stop and, if necessary, wind up in the winding direction of the tension element 12 up to the cable tension associated with the coil spring force, even while the cable reel shaft is motor-driven in the unwinding direction of the tension element 12.

1. A device for receiving and releasing a cable-type tension element, the device comprising:
the cable-type tension element designed to transmit tensile forces,
a receiving unit designed to receive the tension element so that a free length of the tension element extending away from the receiving unit is shortened, or to release the tension element so that a free length of the tension element extending away from the receiving unit is lengthened,
a drive unit designed to drive the receiving unit,
a stop element which is connected to the tension element at a predefined point such that the stop element is immovable at least axially in relation to a longitudinal extension of the tension element, and
a counter-stop element through which at least portions of the tension element are led and which is designed to come into contact with the stop element,
wherein the stop element is connected to the receiving unit such that, after a predefined length of tension element has been released from the receiving unit and has been led through the counter-stop element, the stop element comes into contact with the counter-stop element in a force-transmitting manner.

2. The device according to claim 1,
wherein the stop element is connected to one end of the tension element.

3. The device according to claim 1,
wherein the receiving unit comprises a cable reel designed to wind the tension element onto the cable reel by rotation of the cable reel about an axis of rotation in a first direction of rotation and to unwind the tension element from the cable reel by rotation of the cable reel about the axis of rotation (X) in a second direction of rotation and thus to release the tension element from the receiving unit.

4. The device according to claim 1,
wherein the stop element is connected to the receiving unit in an articulated manner, so as to be pivotable about a pivot axis (Y).

5. The device according to claim 1,
wherein, in a state in which the tension element is received in the receiving unit, the tension element is in contact with the stop element.

6. The device according to claim 3,
wherein the stop element is arranged such that it can be at least partially recessed in relation to an outer circumference of the cable reel, on which outer circumference the tension element is received.

7. The device according to claim 1,
wherein the counter-stop element has a tension element guide which runs through the counter-stop element, the contour of the tension element guide being essentially L-shaped.

8. The device according to claim 7,
wherein one leg of the L-shape of the tension element guide extends in a direction parallel to an axis of rotation (X) of the receiving unit and the other leg extends essentially orthogonally thereto and orthogonally to a longitudinal extension of the tension element in the region of the tension element guide.

9. The device according to claim 1,
wherein the counter-stop element has a counter-stop surface which is oriented and dimensioned such that, when the stop element is in contact with the counter-stop element, surface-to-surface contact between the counter-stop surface and a stop surface formed on the stop element is established.

10. The device according to claim 9,
wherein the stop surface of the stop element is formed on an end face of the stop element.

11. The device according to claim 1,
further comprising a spring element which is designed to preload the receiving unit in such a way that a tension of the tension element is maintained or is restored after a decrease in the tension of the tension element.

12. The device according to claim 1,
wherein the receiving unit comprises a freewheel designed to make a relative movement possible of a first subassembly of the receiving unit, which is operatively connected to the drive unit, relative to a second subassembly of the receiving unit, which is connected to the tension element, in a direction of rotation in which the tension element is received into the receiving unit.

13. A vehicle flap arrangement which comprises a vehicle flap and a device according to claim 1 for receiving and releasing a cable-type tension element,
wherein the vehicle flap is connected so as to be movable relative to a vehicle body,
wherein the tension element connects the device to the vehicle body in the case in which the device is arranged on the vehicle flap and to the vehicle flap in the case in which the device is arranged on the vehicle body.

14. The device according to claim 13,
wherein a longitudinal extension of the tension element guide which extends in a direction parallel to an axis of rotation (X) of the receiving unit, is arranged essentially orthogonally to a main surface of the vehicle flap.

15. The vehicle flap arrangement according to claim 1,
further comprising a guide pulley, the axis of rotation (Z) of which has an angle of approximately 22.5° relative to a plane which is normal to the axis of rotation (X) of the receiving unit.
